(19) United States
(12) Patent Application Publication
(10) Pub. No.: US 2021/0246901 A1
(43) Pub. Date: Aug. 12, 2021

(54) MAGNETICALLY COUPLED PUMP HAVING A DOUBLE-SHELL SPLIT CAN

(71) Applicant: Klaus Union GMBH & Co, KG, Bochum (DE)

(72) Inventor: Thomas ESCHNER, Bochum (DE)

(21) Appl. No.: 16/972,835

(22) PCT Filed: Jun. 6, 2019
(86) PCT No.: PCT/EP2019/064813

§ 371 Date: Dec. 7, 2020

(30) Foreign Application Priority Data
Jun. 7, 2018 (DE) 10 2018 113 636.6

(51) Int. Cl. F04D 13/02; F04D 29/08; F04D 15/02; F04D 29/02; H02K 49/10; H02K 7/14

(52) U.S. Cl. CPC F04D 13/025; F04D 29/086; F04D 15/0263; F05D 2300/2118; H02K 49/106; H02K 7/14; F05D 2300/10; F04D 29/026

(57) ABSTRACT

The invention relates to a magnetically-driven pump (1) with a pump housing (3), a housing cover (4) which closes the pump housing (3), and a containment can (5) which has a metal inner shell (6) and a ceramic outer shell (7) on which a flange (8) is formed. The object of the invention is to devise a pump which is improved in comparison with the prior art, which offers a simple and safe structure and makes uncomplicated and rapid manufacture, assembly and maintenance possible. In particular, a safe and energy-efficient pump is to be devised. To this end, the invention proposes that the inner shell (6) be welded to the housing cover (4) and the outer shell (7) be braced against the housing cover (4) by way of a clamping ring (9) on the flange (8).

The invention relates to a magnetically-driven pump with a receiving pump housing, a housing cover which closes the pump housing, and a containment can which has a metal inner shell and a ceramic outer shell on which a flange is formed.

It is known from the prior art to form containment cans in magnetically-driven pumps with a double-shell configuration, with an inner shell and outer shell, if a high degree of safety is required. These are two containment cans lying one inside the other which are each designed for the operating conditions. If one of the two containment cans is damaged, the system remains hermetically sealed. What is disadvantageous about these double-walled containment cans is that the eddy-current losses during operation are doubled. As a result, the energy consumption of a correspondingly equipped magnetically-driven pump is considerably higher. The heating of the containment cans may in addition result in the pumping medium boiling. Furthermore, the outer shell is not flushed through by the pumping medium, and has to be cooled accordingly. Cooling of the outer shell takes place as a rule by metallic contact with the inner shell, to which the heat is transmitted. The ceramic configuration of the outer shell reduces the heating and improves the energy efficiency, since no eddy-current losses occur in the ceramic material of the outer shell. The remaining heating of the metal inner shell can be controlled by the cooling with the medium which is conveyed.

What is disadvantageous about the double-shell containment cans with a metal inner shell and a ceramic outer shell which have been known hitherto is that they are of complicated construction and therefore the manufacture, assembly and maintenance of the corresponding pumps is costly. In particular the structure of the double-shell containment can from different materials as a rule is difficult to seal off, so the increased safety obtained by the double-shell containment cans is counteracted by additional sealing surfaces.

The object of the invention is therefore to devise an improved pump which offers a simple and safe structure and makes uncomplicated and rapid manufacture, assembly and maintenance possible. In particular, a safe and energy-efficient pump which for example also complies with the DIN/ISO 2858 standard is to be devised.

This object is achieved by a pump having the features of claim 1.

Due to the fact that according to the invention the inner shell is welded to the housing cover and the outer shell is braced against the housing cover by way of a clamping ring on the flange, a simple and safe structure can be devised for a magnetically-driven pump of the type referred to first hereinbefore. The welding of the inner shell to the housing cover makes it possible to economize on a seal between the components which is otherwise conventional. This seal, as a possible weak point in the structure, can thus be dispensed with and the inner shell is connected to the housing cover easily and hermetically by way of a weld seam. With the bracing of the outer shell against the housing cover by way of a clamping ring on the flange, the ceramic outer shell can be fixed on the housing cover in an uncomplicated manner to form the double-shell containment can. The assembly of the pump is simplified in particular in that the housing cover with the two shells of the containment can and the clamping ring can be pre-mounted easily and unproblematically to form a unit.

Advantageous configurations and developments of the invention will become apparent from the dependent claims. It should be pointed out that the features listed individually in the claims may also be combined with one another in any technologically sensible manner whatsoever and thus reveal further configurations of the invention.

According to one advantageous configuration of the invention, provision is made for the pump to have a driver and a rotor between which the containment can is arranged, the rotor being mounted in the containment can by way of a pump bearing, the pump bearing being fastened to the housing cover. With the fastening of the pump bearing to the housing cover, a particularly compact overall form of the magnetically-driven pump can be achieved. Because of the fastening of the pump bearing to the housing cover, which also bears the two shells of the double-shell containment can, in comparison with the prior art a very short overall form is yielded which despite the double-shell construction of the containment can scarcely differs from the overall form of a pump with a single-shell containment can. This has the advantage that the pump with a double-shell containment can can also be manufactured for example in accordance with the DIN/ISO 2858 standard. Thus the proposed pump can easily replace conventional pumps with a single containment can in a connection-compatible manner.

An embodiment which provides for the pump bearing to be fastened to the housing cover by way of a screw connection is particularly preferred. With such a screw connection, the pump bearing can be fastened very easily to the housing cover and be detached easily for maintenance work.

One particularly advantageous embodiment of the invention provides for a flat seal to be arranged between the flange of the outer shell and the housing cover. With the arrangement of a flat seal between the flange of the outer shell and the housing cover, reliable sealing can be achieved. Assembly of the flat seal is considerably simpler than for O-ring seals usually used in the prior art. As a result, firstly the manufacture and assembly of the proposed pump is simplified and secondly the structure is more maintenance-friendly. In addition, a flat seal is more economical and also suitable for higher temperatures. In particular a PTFE-based flat seal, which is distinguished by a high degree of media resistance, high temperature resistance, high achievable tightness and good resistance to ageing and weathering, can be used.

One advantageous embodiment provides for the clamping ring to exert a prestress on the flat seal. The flat seal is braced by the clamping ring between the flange and housing cover, i.e. in the flange connection. By the exerting of a prestress on the flat seal, reliable sealing of the gap between the outer shell and housing cover by the flat seal can be achieved. With the applied prestress on the flat seal, slipping of the seal between the components forming the seal gap can be avoided, which increases the operating safety of the pump.

One particularly advantageous embodiment of the invention provides for a pressure monitoring line which leads into a gap between the inner shell and the outer shell to be formed in the housing cover. By way of the formation of the pressure monitoring line in the housing cover, the space between the inner shell and the outer shell is provided with pressure monitoring. By way of this pressure monitoring, damage to the containment can can be readily ascertained. If the pressure in the gap adopts atmospheric pressure, it can be concluded that there is damage to or malfunction of the outer shell. This damage to the outer shell may occur for example in the event of bearing damage, which results in mechanical contact between the driver and the outer shell. If the pressure in the gap adopts the level of the pumping medium located in the inner shell, it can be concluded from this that the inner shell has been destroyed by abrasion, corrosion or mechanical contact with the rotor and that pumping medium is present in the gap. As a result, faults during operation of the pump can be ascertained very easily, in order to be able to get the damaged pump replaced quickly, namely in good time before the medium escapes from the pump into the environment.

According to a preferred configuration of the invention, provision is made for a pressure sensor for monitoring the pressure in the gap to be connected to the pressure monitoring line. With the arrangement of a pressure sensor on the pressure monitoring line, automated monitoring of the pressure in the gap in the containment can can be carried out. As a result, damage to the inner shell or the outer shell can be ascertained very quickly, so that replacement of the containment can can be initiated immediately. As a result, environmental damage due to the operation of damaged pumps can be reduced.

An embodiment which provides for the inner shell to be formed from a nickel-based alloy is particularly advantageous. Forming the inner shell from a nickel-based alloy has various advantages. With such a nickel-based alloy, a low wall thickness of the inner shell can be produced while having great strength, in particular great hardness, and good corrosion resistance. It is further advantageous that hydrogen embrittlement does not occur with this material, so that hydrogen-containing media can also be conveyed safely with a pump which has a corresponding inner shell.

One particularly advantageous embodiment of the invention relates to the outer shell being formed from zirconium oxide. An outer shell made of zirconium oxide has not only improved corrosion resistance, but also high compressive strength. The wall thickness of the outer shell may be made comparatively low, so that the gap between the driver and rotor can be kept narrow, from which the efficiency of the pump benefits. Of particular advantage are the low eddy-current losses, due to the ceramic, i.e. electrically non-conductive, material. In addition to the mechanical strength even at higher pressures and higher temperatures, zirconium oxide is also very resistant to wear.

One advantageous configuration provides for a flat seal to be arranged between the housing cover and the pump housing, with fastening of the housing cover to the pump housing exerting a prestress on the flat seal. With the arrangement of the flat seal between the housing cover and the pump housing, simple and safe sealing of the pump upon mounting and maintenance can be ensured. The low-priced flat seal can be positioned particularly easily between the pump parts, and an excellent sealing action can be reliably achieved by the prestress on the flat seal.

The invention may relate to a centrifugal pump or alternatively to a screw pump or other magnetically-driven pump.

Further features, details and advantages of the invention will become apparent on the basis of the following description and with reference to the drawings, which show an example of embodiment. Objects or elements which correspond to one another are provided with the same reference numerals in all the figures. These show:

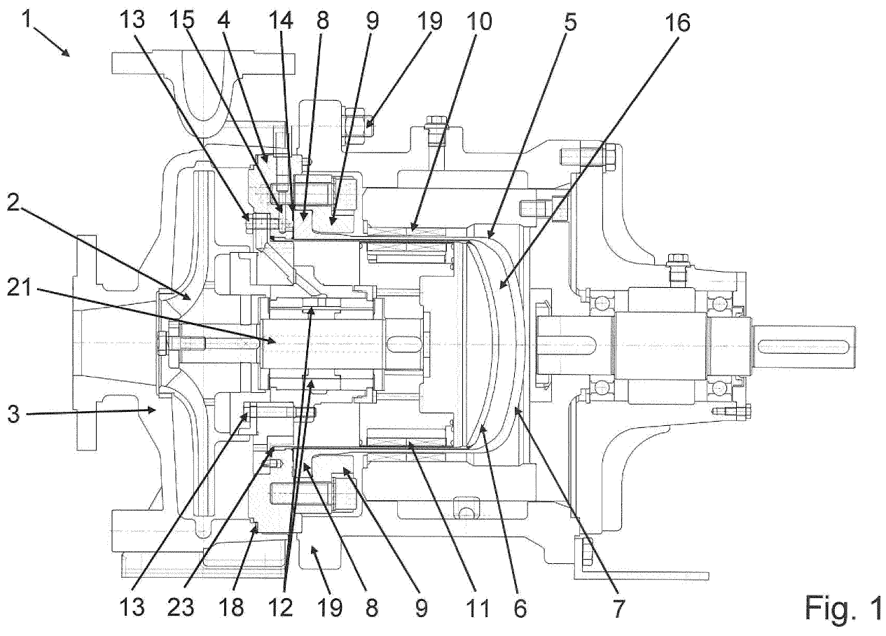

FIG. 1 a sectional view of a pump according to the invention,

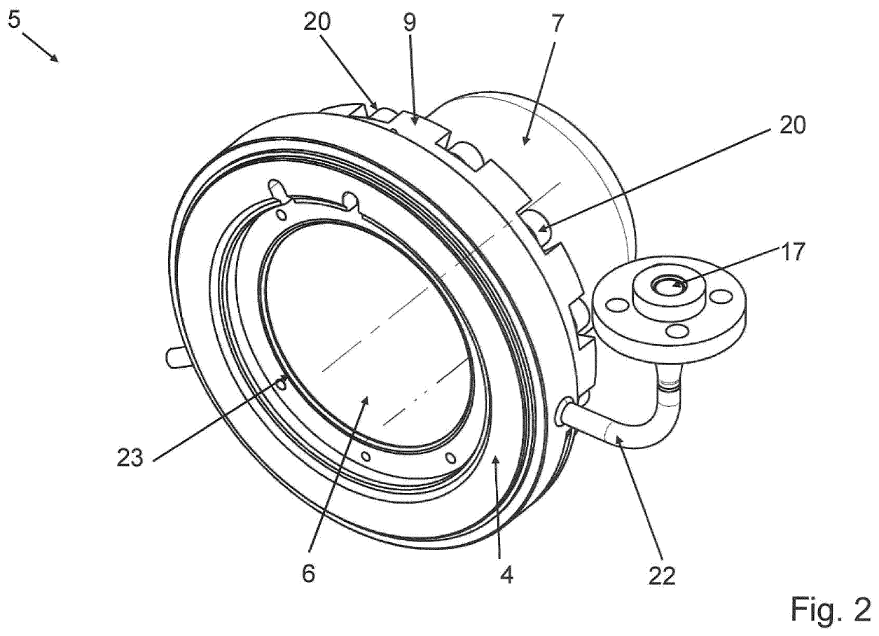

FIG. 2 a view of the containment can,

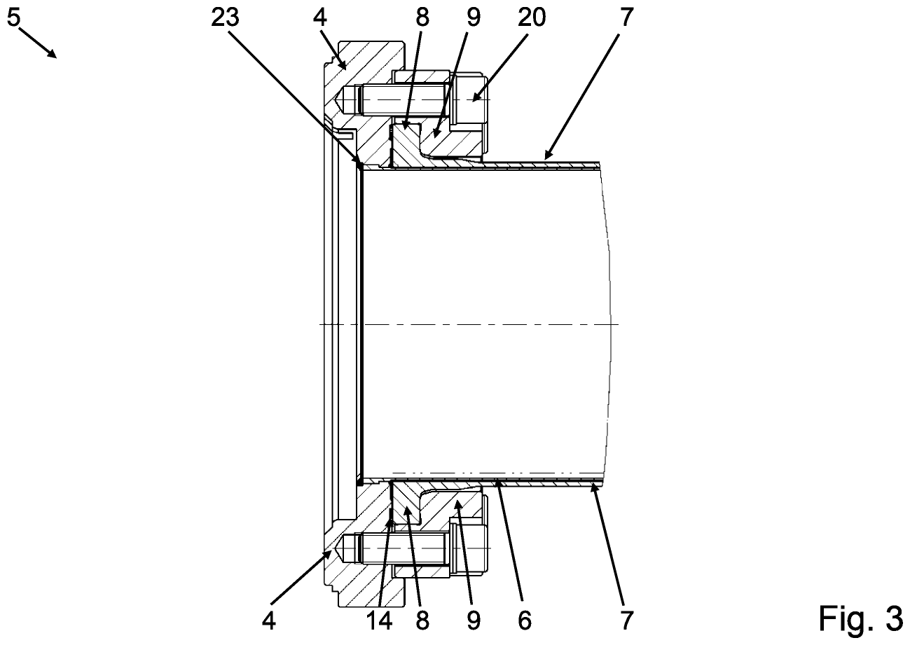

FIG. 3 a sectional view of the containment can,

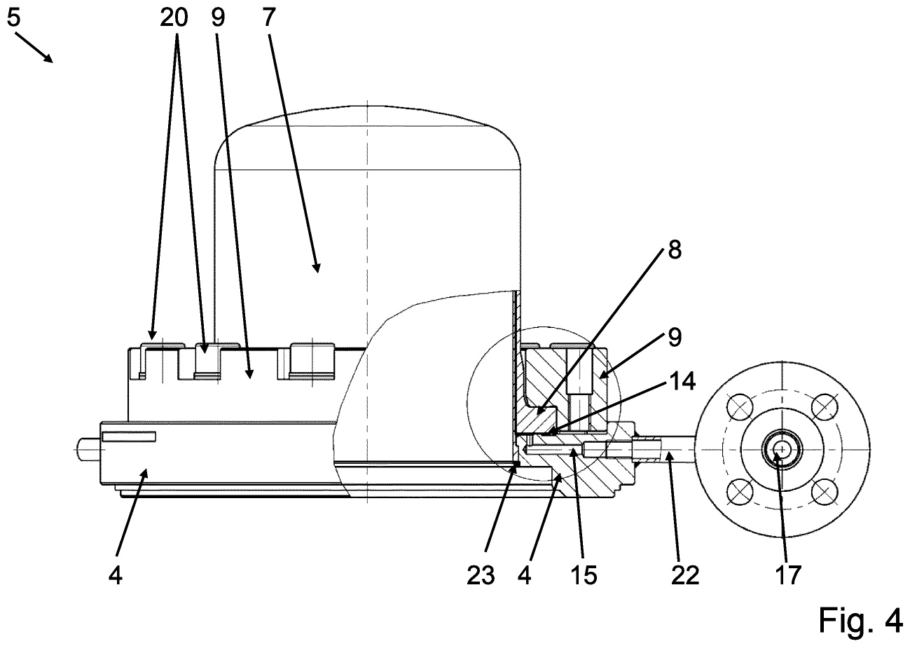

FIG. 4 a side view of the containment can, and

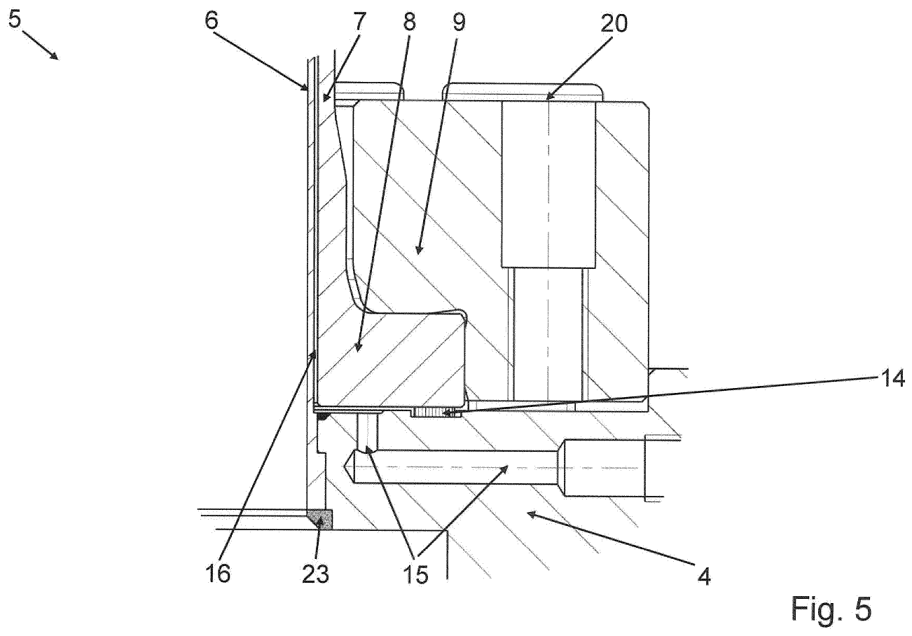

FIG. 5 a detail of the containment can.

In FIG. 1, a pump according to the invention is illustrated, designated overall by the reference numeral 1. The pump 1 illustrated is designed as a magnetically-driven pump 1. In the example of embodiment shown, the pump 1 is designed as a centrifugal pump. The pump 1 has a housing 3 in which an impeller 2 driven by way of the magnetic coupling 10, 11 is accommodated. The pump housing 3 is closed on its right-hand side by a housing cover 4, on which there is arranged a containment can 5 which is positioned between the driver 10 and the rotor 11 of the magnetic coupling 10, 11. The containment can 5 has a metal inner shell 6 and a ceramic outer shell 7. A flange 8 is formed on the ceramic outer shell 7. By way of this flange 8, the outer shell 7 is braced against the housing cover 4 by means of a clamping ring 9. The clamping ring 9 to this end has a screw ring 20, by means of which the clamping ring 9 is screwed to the housing cover 4. The flange 8 on the outer shell 7 is fixed on the housing cover 4 by way of the screw connection of the screw ring 20. The metal inner shell 6 is welded to the housing cover 4 and thus forms a unit with the housing cover 4. The welding is applied around the opening of the inner shell 6 and thus fastens the housing cover 4 hermetically on the inner shell 6. Between the housing cover 4 and the flange 8 of the outer shell 7 there is arranged a flat seal 14 which seals off the gap between the inner shell 6 and outer shell 7 against the housing cover 4. To this end, the clamping ring 9 exerts a prestress on the flat seal 14 and thus ensures a strong sealing action. With the fixing of the outer shell 7 on the housing cover 4 by way of the bracing with the clamping ring 9, a containment can 5 which has a metal inner shell 6 and an outer shell 7 of ceramic material slipped over it can be produced very easily. The sealing by means of the flat seal 14 between the housing cover 4 and outer shell 7 brings about reliable sealing even in the event of temperature fluctuations which have different effects on the materials of the outer shell 7 and the inner shell 6. Preferably the inner shell 6 is formed of a nickel-based alloy. This may for example be Alloy 718, Inconel 718 or Nicofer 5219 Nb or Hastelloy C-4. The outer shell 7 is preferably formed of zirconium oxide (ZrO₂). As can further be seen from FIG. 1, the rotor 10 of the magnetic coupling 10, 11 is mounted in the containment can 5 by way of a pump bearing 12. The pump bearing 12 is connected to the housing cover 4. With the fastening of the pump bearing 12 to the housing cover 4, a particularly compact overall form of the pump shown here can be produced, since the pump bearing 12 is arranged within the double-shell containment can 5. As a result, the pump shaft 21, which transmits the rotary movement from the rotor 10 to the impeller 2, can be made particularly short. This compact overall form makes it possible to make a magnetically-driven pump 1 equipped with a double-shell containment can 5 so compact that the chemical standard DIN/ISO 2858 is complied with. As a result, the pump 1 shown is particularly suitable for increasing operating safety in production plants in the chemical industry. The pump 1 shown may be used here in a connection-compatible manner as a replacement for other pumps, e.g. those with a single-shell containment can. The pump bearing 12 is fastened to the housing cover 4 by way of a screw connection 13. As a result, the pump bearing 12 can be mounted very easily. Even in the event of maintenance work, the pump bearing 12 can be separated from the containment can 5 very easily. It is furthermore shown in FIG. 1 that a pressure monitoring line 15 is set into the housing cover 4. The pressure monitoring line 15 leads into the gap 16 which is formed between the inner shell 6 and the outer shell 7. The pressure in the gap 16 can be monitored by way of the pressure monitoring line 15 which leads into the gap 16. As a result, leaks or damage to the inner shell 6 and the outer shell 7 can be detected easily. A pressure sensor 17 which permits automatic pressure monitoring may be connected to the pressure monitoring line 15 for monitoring the pressure in the gap 16. To seal off the pump 1, a further flat seal 18 is arranged between the housing cover 4 and the pump housing 3. Due to the fastening 19 of the housing cover 4, said cover is pressed against the pump housing 3 and thus exerts a prestress on the flat seal 18 arranged between the pump housing 3 and housing cover 4. This makes reliable sealing of the pump housing 3 possible.

The containment can 5 of FIG. 1 can be seen in a perspective view in FIG. 2. It can be recognized that the clamping ring 9 produces the prestress with which the flange 8 of the outer shell 7 is braced against the housing cover 4 by way of a screw ring 20. Guided laterally out of the housing cover 4 there is a pressure transmission line 22, to which a pressure sensor 17 is connected. The pressure transmission line 22 is guided by way of a pressure monitoring line 15 (FIG. 1), which is formed in the housing cover 4, into the gap 16 between the inner shell 6 and the outer shell 7. This makes it possible to monitor the pressure in the gap 16.

FIG. 3 shows a portion of a sectional view through the containment can 5 of FIG. 2. It can be seen from this representation that the clamping ring 9 braces the flange 8 of the outer shell 7 against the housing cover 4, which is welded to the inner shell 6 by way of a welded joint 23. The clamping ring 9 exerts a prestress on the flat seal 14 arranged between the housing cover 4 and the outer shell 7. The prestress of the clamping ring 9 is produced by way of the screws of the screw ring 20.

FIG. 4 shows a further view of the containment can 5. In the side view, a part is illustrated cut away, so that it is possible to view the pressure monitoring line 15 formed in the housing cover 4.

This cut-away region is illustrated more precisely in FIG. 5. It can be recognized how the pressure monitoring line 15 is guided into the gap 16 between the inner shell 6 and the outer shell 7. This makes it possible to monitor the pressure in the gap 16 between the inner shell 6 and the outer shell 7 of the containment can 5. In this detail view, the flat seal 14 arranged between the flange 8 of the outer shell 7 and the housing cover 4 can also be clearly recognized, on which seal the clamping ring 9 exerts a prestress through the screw connection by way of the screw ring 20. The weld seam 23 between the inner shell 6 and housing cover 4 can also be clearly recognized in FIG. 5. It is apparent from this that the weld seam 23 is formed as a fillet weld and therefore is simple to manufacture. In addition, the fillet weld offers reliable sealing and fastening between the housing cover 4 and the inner shell 6.

### List of Reference Numerals

1 pump
2 impeller
3 pump housing
4 housing cover
5 containment can
6 inner shell
7 outer shell
8 flange
9 clamping ring
10 driver
11 rotor
12 pump bearing
13 screw connection
14 first flat seal
15 pressure monitoring line
16 gap
17 pressure sensor
18 second flat seal
19 fastening
20 screw ring
21 pump shaft
22 pressure transmission line
23 welded joint

1. Magnetically-driven pump with
a pump housing,
a housing cover which closes the pump housing, and
a containment can which has a metal inner shell and a ceramic outer shell on which a flange is formed,
wherein the inner shell is welded to the housing cover and the outer shell is braced against the housing cover by way of a clamping ring on the flange.

2. Magnetically-driven pump according to claim 1, wherein the pump comprises a driver and a rotor between which the containment can is arranged, wherein the rotor is mounted in the containment can by way of a pump bearing, wherein the pump bearing is fastened to the housing cover.

3. Magnetically-driven pump according to claim 2, wherein the pump bearing is fastened to the housing cover by way of a screw connection.

4. Magnetically-driven pump according to claim 1, wherein a flat seal is arranged between the flange of the outer shell and the housing cover.

5. Magnetically-driven pump according to claim 4, wherein the clamping ring exerts a prestress on the flat seal.

6. Magnetically-driven pump according to claim 1, wherein a pressure monitoring line is formed in the housing cover, which line runs in a gap between the inner shell and the outer shell.

7. Magnetically-driven pump according to claim 6, wherein a pressure sensor for monitoring the pressure in the gap is connected to the pressure monitoring line.

8. Magnetically-driven pump according to claim 1, wherein the inner shell is formed from a nickel-based alloy.

9. Magnetically-driven pump according to claim 1, wherein the outer shell is formed from zirconium oxide.

10. Magnetically-driven pump according to claim 1, wherein a flat seal is arranged between the housing cover and the pump housing, wherein a fastening of the housing cover to the pump housing exerts a prestress on the flat seal.
